(19) United States
(12) Patent Application Publication
(10) Pub. No.: US 2021/0248545 A1
(43) Pub. Date: Aug. 12, 2021

(54) METHOD FOR DESIGN AND TEST OF LOGISTICS AND MATERIAL HANDLING SYSTEMS

(71) Applicant: BEUMER Group A/S, Aarhus N (DK)

(72) Inventors: Søren Mikkelsen, Risskov (DK); Søren Nyboe Laursen, Skanderborg (DK); Jan Rasmussen, Hadsten (DK); Niels Døssing, Lystrup (DK); Allan Christensen, Aarhus (DK); Lars Guldager Ardal, Silkeborg (DK)

(73) Assignee: BEUMER Group A/S, Aarhus N (DK)

(21) Appl. No.: 16/973,212

(22) PCT Filed: Jun. 7, 2019
(86) PCT No.: PCT/DK2019/050178

§ 371 Date: Dec. 8, 2020

(30) Foreign Application Priority Data
Jun. 13, 2018 (DK) PA 2018 70386

(51) Int. Cl. G06Q 10/08

(52) U.S. Cl. CPC G06Q 10/087

(57) ABSTRACT

The invention provides a computer implemented method for test of a control system for a logistics system. The method comprises testing (TST1, TST2) one or more low level control (LLC) software parts by simultaneously emulating a high level (HLE) response, emulating a low level emulating (LLE) response, and interfacing (INF) said HLE and low level emulation LLE. The interfacing (INF) of the HLE and LLE, comprises two-way exchanging a plurality of parameters (P) indicative of items to be handled in the logistics system between the HLE and the LLE. With such interfacing of a HLE for testing of a high level control (HLC) software of the logistics system, and the LLE for, it is possible to provide a realistic test and tuning of LLC software parts, e.g. Programmable Logic Controllers (PLCs) code, before the physical elements of a complex logistics system is built, e.g. an airport baggage handling system. This can reduce time and costs involved in final testing and tuning of parameters in the LLC software parts on-site, when the total system has been built.

### FIELD OF THE INVENTION

The invention relates to the field of logistics and material handling systems, such as systems for transporting and sorting objects or materials, such as parcels, baggage items or other type of items. In particular, the invention provides a method and a system for emulating realistic conditions for design and test of control components for a logistics or material handling system before the system components are assembled.

### BACKGROUND OF THE INVENTION

Baggage handling systems, e.g. for a large airport, are highly complex logistic systems with many single elements, including tens of kilometres of conveyers, sorters, inductions, and discharge stations for transporting baggage and other items from one position to another position at a high speed and with correct timing to provide a high capacity. Each of the elements further include a number 20 of sub elements, such as switches, sensors, ID scanners, motors, actuators etc. to be controlled precisely in order for the entire system to be able to route each single baggage item in the most optimal way to reach its destination as fast as possible, or at a specific target time.

In practice, when such complex baggage handling system is built, a significant amount of resources is spent on manual testing and tuning of various timing parameters etc. in the controllers which control the large number of individual controllable sensors and actuators. Thus, in spite of careful design, test and verification of each individual element of the entire system, optimal performance 30 of the system requires significant time and costs involved after the entire system has been assembled. For e.g. a large airport to function on a daily basis before a new baggage handling system is finally launched, such time spent on system modifications on-site may create many practical problems, and the resources spent thereon constitutes a significant part of the total costs involved in a baggage handling system.

### SUMMARY OF THE INVENTION

Thus, according to the above description, it may be seen as an object of the present invention to provide a solution to eliminate or at least reduce the large resources required to optimize function of a complex logistics system when finally assembled on-site.

In a first aspect, the invention provides a computer implemented method for test of a control system for a logistics system, the method comprising
emulating a high level (HLE) response of an overall layout of the logistics system for testing a high level control (HLC) software for overall control of the logistics system,
emulating a low level (LLE) response of physical elements of the logistics system for testing one or more low level control (LLC) software parts for control of physical elements of the logistics system,
interfacing the HLE and the LLE, by two-way exchanging a plurality of parameters indicative of items to be handled in the logistics system between the HLE and the LLE, and
testing one or more LLC software parts by simultaneously emulating said high level response, emulating said low level response, and interfacing said HLE and LLE.

The invention is based on the insight of the inventor that design and test of control software for complex logistics systems, such as airport baggage handling systems, is most often split between what can be called high level control (HLC) software, and a (high) number of low level control (LLC) software parts. The HLC software is the overall software of the logistics system to handle which items to go where, and when, utilizing the overall layout of the logistics system. The HLC software will typically be executed by a server, and it may be programmed in a program language such as C, C++, C#, Java, Python, etc. The LLC software parts implement control algorithms for controlling logic and timing between sensor inputs and actuator outputs for each separate element of the logistics system. It may especially be program code for a programmable logic controller (PLC) that controls the function of actuators, motors, servos etc. in response to a number of switches, ID scanners, speed sensors, acceleration sensors, and other inputs. In an airport baggage handling system, e.g. 10-100 of such LLCs can be included to control the function of the physical elements of the system, e.g. conveyors belts, inductions, discharges etc.

The HLC software and the LLC software parts are developed in completely separate processes and by different staffs or teams, e.g. at different locations. The overall control software can be tested with a high level emulator (HLE) software that mimics the real world system to a high degree of realism, including relevant aspects of the physical system. Such HLE software helps software engineers to develop the control software, e.g. taking realistic input/output baggage data from a real life airport, and allows testing of various scenarios. Once the overall layout of the system has been decided, the HLC software is designed, and its function is tested and tuned using a HLE.

Each of the LLC software parts of the entire system are developed and tested with an LLE—completely separate from the HLC development. Thus, in a normal process, the HLC and LLC software parts are tested together for the first time on-site, when the physical elements have been installed. Finally, at this point in time, the staff and time demanding testing of LLC software parts can begin. In spite of the completely different natures of the HLC and LLC software, and thus also the HLE and LLEs, the invention provides an interfacing between the two, which allows each LLC software part of the system to be tested in the design phase. However, still the cooperation of all elements in the actual setup is complex and calls for manual testing and tuning of e.g. timing parameters in all individual LLC software components for optimal function of the entire system under actual operating conditions. In large systems with 10-100 separate LLC software parts with program code, e.g. PLC program code, serving to implement control algorithms for various inputs and outputs from/to such as 1000 or more single physical transportation elements of the system, such manual testing and tuning is extremely resource demanding.

Based on this insight, the inventor has solved the above-mentioned problem by providing a software package including a high level emulator (HLE) software which can be used to design and test the HLC software of the logistics system, and one or more low level emulators (LLEs) software parts, which can be used to design and test function of each of the LLC software parts. The software package comprises a data interface serving to provide two-way data exchange between the HLE software and the LLE software parts. This allows emulation of the overall HLC software functioning together with emulation of all relevant LLC software parts.

Such method is advantageous, since providing an interface between the HLE and the LLE, it allows both the HLC software and one or more LLC software parts to be tested together with realistic input data. This allows testing of e.g. several LLC software parts together under realistic conditions, where each LLC software part interacts with the HLC software and in preferred embodiments, the interfacing includes emulating response of an interconnection between at least two LLC software parts for realistic emulation of signals communicated between neigbouring LLC controls. Altogether, this allows very realistic conditions for testing of LLC software parts, thus allowing tuning of various parameters, such as timing etc. in the LLC software code, before the total system is physically installed on-site. Especially, for logistics systems with a high capacity, the tuning of various timing parameters is essential. With an item transporting speed of such as 2 m/s or even more, a mis-timing of a few ms can be essential to avoid mis-timing that may slow down the conveying, e.g. start-up timing of motors e.g. on neigbouring conveyor elements and the like, to provide a smooth transport of items without any stopping. With the method according to the invention, this can now be tested and tuned in the design phase of the system, thus saving a large amount of resources.

As an example, for an airport baggage handling system, real-life input baggage data from an airport can be used to run a test of the entire system functioning together, before it is physically built. Hereby, it is possible to tune various timing parameters etc. in the control algorithms of the LLCs, thus saving a significant amount of man power which is otherwise required on-site after installation of the physical system.

It is to be understood that the complete software package required for HLE and LLE and the interfacing can be implemented in various ways. Either existing HLE and LLE components can be modified to input/output the relevant data for the interfacing, and the interface part can be programmed as a hybrid interface e.g. including emulation of intercommunication between LLCs. Thus, the hybrid interface can be considered as an add-on to existing LLE and HLE tools. Alternatively, an integrated software package including HLE, interfacing and LLE can be provided.

By ‘low level emulator’ is understood emulation models replacing the physical equipment, for example a conveyor line, and can be controlled e.g. by a single PLC. The software that is tested with low-level emulation is the transport layer, and the models developed to do so are designed to produce the same electrical outputs and respond to the same electrical inputs as their corresponding physical equivalent (motors, photo-electric cells, barcode scanners, and the like). Thus, LLE program code is preferably configured to emulate electric inputs and outputs of the physical elements of the logistics system.

By ‘high level emulator’ is understood emulation models that can be used to test the entire system, thus to test the HLC, but also to test subsystems in isolation. The model used does not only emulate LLCs (PLCs) and equipment, it is also possible to emulate complete subsystems. This makes it possible to test the behaviour of a single component within the entire system without the disturbance of other components.

In the following, preferred features and embodiments will be described.

The plurality of parameters indicative of items to be handled comprises at least one parameter indicative of one of: a unique identity for each item, and a time stamp associated with location of each item in the overall layout. Preferably, the plurality of parameters indicative of items to be handled comprises at least one parameter indicative of one of: destination of the item, content of the item, and status information.

In a preferred embodiment, the interface is configured to allow real-time two-way exchange of at least three parameters unique for each items to be handled, e.g. including destination, content and timing data unique for each item.

The LLE program code is preferably configured to emulate response of a plurality of physical elements associated with a plurality of LLC software parts. Especially, the interfacing further comprises emulating response of an interconnection between at least two LLC software parts. This allows a realistic emulation of e.g. two or more LLCs for controlling neighbouring physical elements, since such LLCs will in the physical setup interchange data. In a practical system such data may be a “heartbeat” signal to communicate that the unit is in normal operation, information about motor speeds, and timing regarding expected arrival of next item to allow the following element to start up motors in order to obtain the correct speed for seamless receipt of the upcoming item. Thus, preferably, said response of the interconnection between at least two LLC software parts may comprise generating data indicative of at least one of: a motor speed, a timing parameter, and a status parameter. Preferably, said response of the interconnection between at least two LLC software parts comprises generating data indicative of a plurality of parameters relating to the physical elements. Such part of the interfacing may be rather complex in case of several LLCs interacting with each other.

A plurality of LLC software parts may be simultaneously tested, or at least emulated, so as to test one LLC software part out of a system of many interacting LLC software parts.

It is to be understood that the method can be implemented with various software configurations. Especially, it may be preferred that the HLE and the LLE are executed on separate processors, such as HLE being executed on a first processor, and the LLE being executed on a second processor. This allows faster execution of the emulation and testing, since the computation task is distributed to more processors. If preferred, one single computer, e.g. server or one server system, may be used to execute all software parts involved, i.e. HLE, LLE, and interfacing, e.g. to be operated by an online terminal to allow a software engineer to perform testing and tuning of LLC software parts from anywhere. Especially, the interfacing may be executed partly on the first processor and partly on the second processor. Specifically, the HLE and the LLE are executed on separate computers interconnected by a network, e.g. the internet. This may allow a faster and more flexible execution and LLC testing procedure.

The method may comprise receiving a set of input data for a plurality of items originating from a real-life logistics system, and applying said set of input data to the HLC software. E.g. for an airport baggage handling system, a real-life set of baggage data arriving from aircrafts and expected destinations etc. can be provided as input to an LLC software testing session in order to run the entire emulation under realistic conditions.

A preferred method comprises changing at least one parameter in at least one of the one or more LLC software parts, and repeating said step of simultaneous testing, so as to test the result of the changed parameter(s), e.g. timing parameter(s).

Preferably, the method comprises visualizing to a user at least a part of the logistics system and at least one item being transported therein to a user along with said step of testing. The visualization preferably allows opening data windows to allow following various parameters online states of the LLC software part under test.

The one or more LLC software parts to be tested may be PLC software parts or software parts for Field Programmable Gate Arrays (FPGAs), or more alternatively software parts for soft PLCs, or more alternatively software parts for execution on a general computer.

The emulation and testing may be performed in real-time, or alternatively faster than real-time, if the necessary computation power allows to do so, so as to speed up testing of the LLC software part. Especially, if faster than real-time can be obtained, this allows even faster testing and tuning of parameters in the LLC software parts.

In a second aspect, the invention provides a computer system comprising at least one processor and a memory and being programmed for carrying out the method according to the first aspect.

In a third aspect, the invention provides a computer program product having instructions which when executed cause a computing system to perform the emulating of a HLE response, the emulating of a LLE response, and the interfacing INF according to the method of the first aspect. Especially, the computer program product can be one of: a software product for a general computer, a server software product, and a plurality of separate software products configured for execution on separate processors.

In a fourth aspect, the invention provides a computer readable medium having stored thereon a computer program product according to the third aspect.

In a fifth aspect, the invention provides use of the method according to the first aspect for test of a control system for a logistics system being one of: an airport baggage handling system, a mail or parcel sorting system, an item or material storage facility, and a material conveying system.

In a sixth aspect, the invention provides a logistics system for handling items, the system comprising
a plurality of physical elements comprising
   at least one conveyor section arranged to transport a stream of items,
   at least one induction arranged for transporting items to the at least one conveyor,
   at least a discharge arranged for discharging items from the at least one conveyor, and
a control system for controlling the physical elements, wherein the control system comprises a computer system programmed to control the physical elements according to a HLC software and one or more low level control (LLC) software parts, wherein said HLC software and one or more LLC software parts have been tested according to the method according to the first aspect.

The logistics system may e.g. be: an airport baggage handling system, a mail or parcel sorting system, an item or material storage facility, or a material conveying system, such as a mining industry material conveying system.

The system may especially comprise a plurality of conveyors and one or more sorters, e.g. comprising a plurality of supporting surfaces arranged to move along a track in a transporting direction, wherein the supporting surfaces define empty spaces for receiving and transporting items. The sorter may be of a type as for example: a tilt-tray sorter, a cross-belt sorter, a tote based sorter, a pusher sorter, a shoe sorter, or a pop-up sorter. Especially, the sorter may be a closed loop type of sorter.

The system may be arranged to transport items, e.g. totes, with a speed of at least 0.4 m/s, such as 0.5-1.0 m/s, such as 1.0-1.5 m/s, such as 1.5-2.0 m/s, such as more than 2.0 m/s. Especially, the system may be arranged to transport items at a constant speed, which is demanding and requires precise timing and coordination, especially when handing over an item from one physical element controlled by one LLC software part to another physical element controlled by another LLC software part. This can be tested and tuned with the present invention.

The system may further comprise a plurality of discharges arranged for receiving items from the sorter, wherein the discharges are arranged at different positions adjacent to a sorter. Especially, the system may be arranged to discharge items from the sorter at discharge locations selected in accordance with an identification code associated with the individual items. E.g. such identification code can be such as: a bar code, a postal code, an ID tag, RFID tag, or the like. By scanning the identification code of an item, the sorter system is capable of sorting the item accordingly.

It is understood that the function of the HLC software is to be executed on a computer system with at least one processor, and this can be can be implemented in various ways. The LLC software part(s) can be executed on various processor platforms, e.g. on Programmable Logic Controllers (PLCs), soft PLCs, or other computer platforms.

In a seventh aspect, the invention provides use of a system according to the second aspect for: handling baggage in an airport, sorting mail or parcel items in a mail sorting centre, handling an item or material in a storage facility, and handling material in a conveying system, such as a mining industry conveying system.

It is appreciated that the same advantages and embodiments described for the first aspect apply as well for the other mentioned aspects. Further, it is appreciated that the described embodiments can be intermixed in any way between the mentioned aspects.

### BRIEF DESCRIPTION OF THE FIGURES

The invention will now be described in more detail with reference to embodiments and regard to the accompanying figures of such embodiments, of which

FIG. 1 illustrates a sketch of a layout of a small part of a large complex logistics system to illustrate the different roles of high level emulation and low level emulation, and

FIG. 2 illustrates a block diagram of an example of software components for implementing the low level control testing method,

FIG. 3 illustrates an example of a screen shot as an example of visualization of baggage flow in a high level control emulation,

FIG. 4 illustrates an example of a screen shot as an example of visualization of baggage flow for testing a low level part in an emulation session,

FIG. 5 illustrates elements of a simple logistics system, and

FIG. 6 illustrates steps of a preferred method embodiment.

The figures illustrate specific ways of implementing the present invention and are not to be construed as being limiting to other possible embodiments falling within the scope of the attached claim set.

### DETAILED DESCRIPTION OF EMBODIMENTS

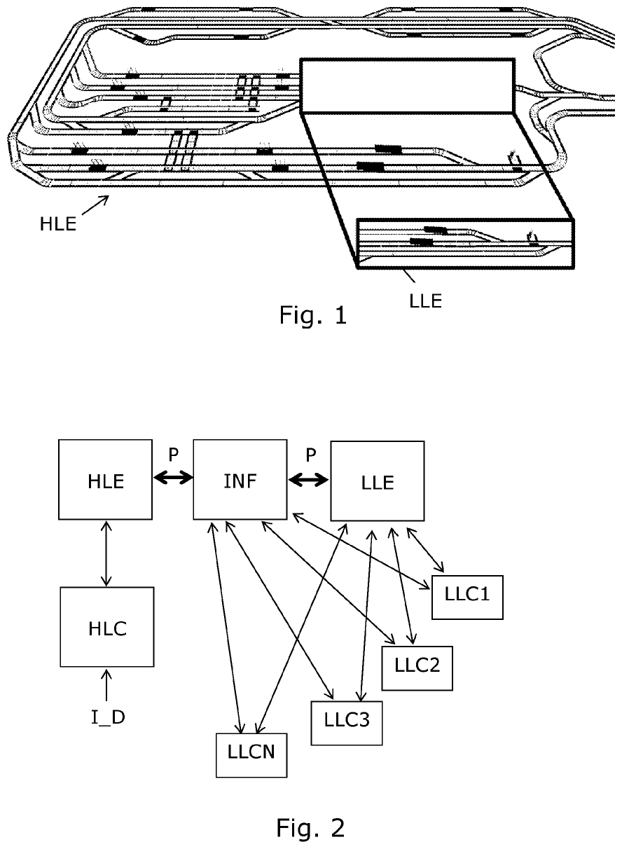

FIG. 1 illustrates a block diagram of a layout of part of a complex baggage handling system for an airport. The overall layout and routing of baggage items on totes with unique identification codes on each baggage item is handled by a high 35 level control (HLC) software. The function of this HLC software can be tested by means of a high level emulator HLE which emulates the transport of baggage items between a high number of physical elements of conveyors, sorters, inductions, discharges etc. each of which are controlled by low level controllers (LLCs) controlled by LLC software parts. Each of these LLCs can be emulated by respective low level emulators LLE, which mimic the electric input and output involved in the motors, actuators, ID scanners, and other sensors to be handled by a LLC. As indicated, the high level emulator HLE is not involved in the many signals involved in the LLC, but rather emulates this as a “black box”. Thus, in prior art baggage handling system design, the HLC is developed and tested by a HLE, and each sub system controlled by an LLC are separately developed and tested with LLEs. When the physical system has been setup, the various LLC software parts are then tested and tuned for optimal function on-site, since this is where HLC and LLC parts are combined for the first time.

According to a method of the present invention, the HLE and LLE are combined, so as to enable testing of each LLC software part in the design phase, before the physical system is built. This will be explained in the following.

FIG. 2 illustrates components of the invention, namely a high level emulator HLE, a low level emulation LLE, and an interface INF allowing a two-way exchange of a plurality of parameters P indicative of items to be handled in the logistics system between the HLE and the LLE. This allows testing with a realistic set of input data I_D, e.g. baggage item IDs, arrival place and time, destination place and time etc., to be input to the HLE and by simultaneously executing the HLE, HLC software, the interface INF and the LLE connected to LLCs: LLC1, LLC2, LLC3, LLCN, each being controlled by a program code for control of physical elements of the system, e.g. motors for driving conveyors, scanners, sensors, which responses are emulated by the LLE, and this communication is indicated with double arrows between each LLC1, LLC2, LLC3, LLCN and the LLE. Further, the interface INF is programmed to emulate the intercommunication between neighbouring LLCs. This is indicated by double arrows between each LLC1, LLC2, LLC3, LLCN and the INF, and this includes signals communicating timing of arrival of a baggage item, e.g. so as to allow a down stream element to start up an electric motor for correct conveyor speed in time, as well as a “heartbeat” signal to communicate to the neighbour controller that it is in normal function.

In a baggage handling system where baggage items are carried by totes, the parameters P include such as:
1. a unique ID for each tote carrying a baggage item,
2. data indicating content of the tote,
3. data indicating destination of the tote,
4. status informations, and
5. a time stamp, so as to keep track of arrival of the tote at the various locations in the system.

It is to be understood that the above parameters P are examples only of relevant parameters P for a tote based baggage handling system, e.g. for an airport. For a specific logistics system, the relevant parameters P have to be specifically selected to cover the relevant data in such system.

For a high capacity complex baggage handling system, the amount of parameters P to be interfaced by the interface INF between the HLE, the LLE, and the LLCs total data capacity to allow real-time tracking of baggage items for testing of LLC program code timing parameter is high.

In the physical system, the various signals between the HLC and each LLC, and between the LLCs are in the form of digital signals communicated via networks. Thus, the HLE, the LLE, and the interface are preferably implemented on a computer system arranged to input and output digital signals via a network protocol similar to the one to be used for the physical system.

In a preferred embodiment, the invention provides testing each of the LLC software parts LLC1, LLC2, LLC3, LLCN by simultaneously executing the HLE, the 30 HLC, the interfacing INF, and the LLE in a set of input data I_D. Preferably, all of the LLCs LLC1, LLC2, LLC3, LLCN are also executed at the same time, so as to allow the entire system to function as close as possible to realistic operating conditions, while the system is still in the “test bench” without any physical motors, sensors, conveyors etc. involved.

This allows software engineers to test and optimize functions of the LLCs LLC1, LLC2, LLC3, LLCN under conditions which are very similar to the situation where the complete physical baggage handling system has been built on-site. This will save significant costs involved for on-site testing and tuning of timing parameters etc.

The programming of the elements HLE, INF, and LLE may be performed as known by the skilled software engineer or programmer. Either the interface part INF may be a stand-alone piece of software, or an integrated package including all of HLE, INF, LLE may be provided. E.g. the HLE and LLE components may be designed for respective computers interconnected e.g. by the internet, so as to allow a HLC development team to be geographically separated by an LLE development team.

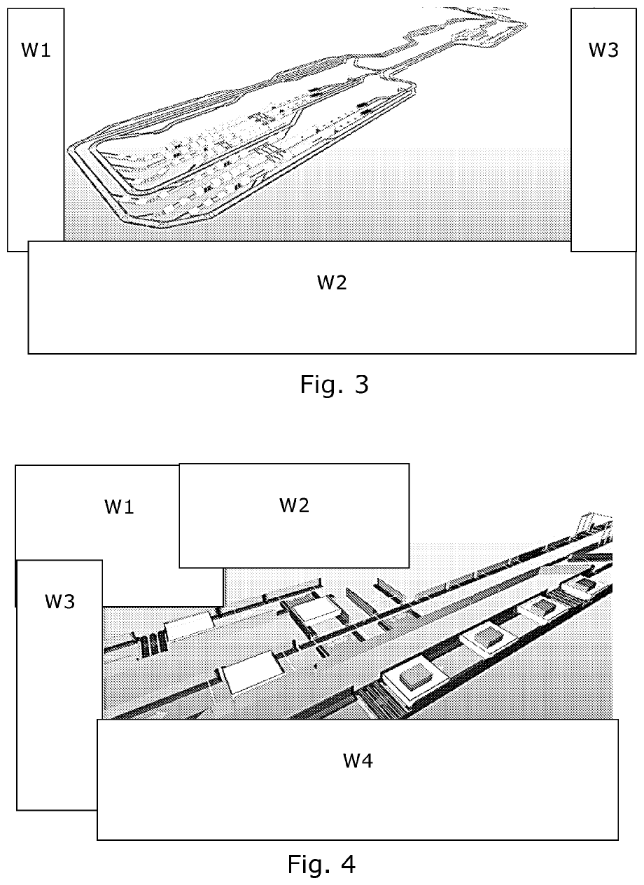

FIG. 3 shows an example of a screen shot for illustration of a visualization of a live update of the location of each tote carrying item in a baggage handling system during the simultaneous execution of the HLE, LLE, INF components for testing the function of software parts of the LLCs LLC1, LLC2, LLC3, LLCN. The windows W1, W2, W3 merely indicate that various data can be followed in the live update.

FIG. 4 shows an example of a screen shot of a visualization of a live update of the location of totes and baggage items in a more detailed view, e.g. zoomed to elements controlled by one LLC, or zoomed to illustrate interfacing physical elements which are controlled by two different LLCs. This allows hand-over timing of totes etc. Again, W1, W2, W3, W4 illustrate windows where various data can be followed in real-time, e.g. arrival times at various locations for one tote.

As mentioned, if preferred, and if computation power allows to do so, the system can be tested faster than real-time, so as to speed up the testing procedure, thus allowing easy and fast testing of the effect of changing one parameter value in an LLC software part.

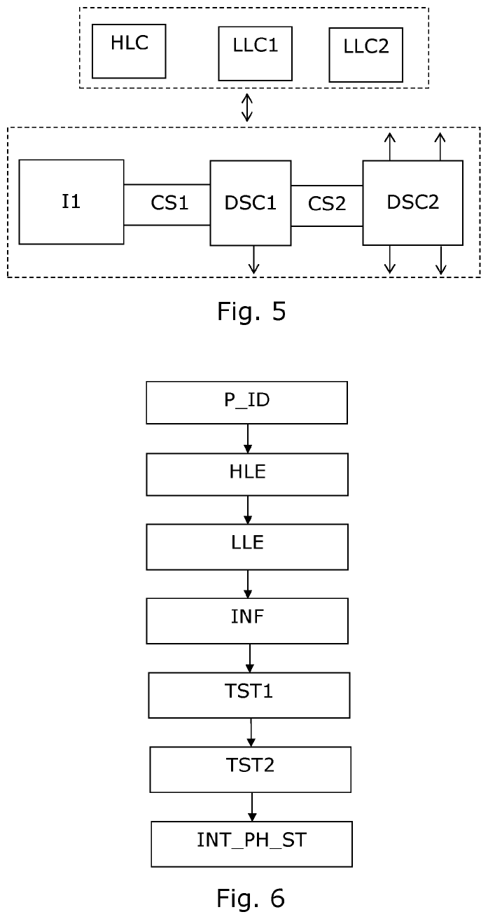

FIG. 5 shows a sketch of an example of basic components of a baggage handling system. The physical elements of the system comprises an induction I1 for inducting baggage items to a first conveyor section CS1. A first discharge DSC1 for discharging baggage items is arranged between the first conveyor section CS1 and a second conveyor section CS2. A second discharge DSC2 is arranged downstream of the second conveyor section CS2.

The physical elements I1, CS1, CS2, DSC1, DSC2 are controlled by a high level controller HLC which is connected via a digital data network with low level controllers LLC1, LLC2, e.g. PLCs, for handling electric inputs and outputs from the physical elements I1, CS1, CS2, DSC1, DSC2.

Preferably, the HLC, LLC1, LLC2 components have been tested according to the method of the invention as decribed in the foregoing, prior to connection to an on-site setup of the physical elements I1, CS1, CS2, DSC1, DSC2. This will significantly reduce the time required for on-site testing.

FIG. 6 illustrates steps of a method embodiment for testing LLC software parts in an air baggage handling system prior to building the physical system, but after the overall layout of the configuration of the system and corresponding high level control HLC software has been designed.

First step is providing P_ID input data, e.g. real-life data taken from an existing airport. Next, emulating HLE a high level response of an overall layout of the logistics system for testing HLC software for overall control of the logistics system. Next, emulating LLE a low level response of physical elements of the logistics system for testing one or more LLC software parts for control of physical elements of the logistics system. Next, interfacing INF the HLE and the LLE, by two-way exchanging a plurality of parameters indicative of items to be handled in the logistics system between the HLE and the LLE. Wherein the parameters preferably comprises a unique baggage item and/or tote identification, as well as timing data for arrival of the baggage item and/or tote at specific locations. Next, performing a first testing TST1 of at least one LLC software parts by simultaneously emulating said HLE response, emulating said LLE response, and interfacing INF said HLE and LLE. After the first testing, preferably visualized on a display, at least one parameter is changed in the LLC software part in response to a result of the first testing TST1. Next, performing a second testing TST2 of the LLC software for monitoring the effect of the parameter change. Of course this may be repeated a number of times to tune each parameter of the LLC software part, until e.g. a timing parameter has been tuned for a smooth hand over of a tote between two physical elements, e.g. conveyor sections, controlled by different LLCs.

To sum up, the invention provides a computer implemented method for test of a control system for a logistics system. The method comprises testing (TST1, TST2) one or more low level control (LLC) software parts by simultaneously emulating a high level (HLE) response, emulating a low level emulating (LLE) response, and interfacing (INF) said HLE and low level emulation LLE. The interfacing (INF) of the HLE and LLE, comprises two-way exchanging a plurality of parameters (P) indicative of items to be handled in the logistics system between the HLE and the LLE. With such interfacing of a HLE for testing of a high level control (HLC) software of the logistics system, and the LLE for, it is possible to provide a realistic test and tuning of LLC software parts, e.g. Programmable Logic Controllers (PLCs) code, before the physical elements of a complex logistics system is built, e.g. an airport baggage handling system. This can reduce time and costs involved in final testing and tuning of parameters in the LLC software parts on-site, when the total system has been built.

Although the present invention has been described in connection with the specified embodiments, it should not be construed as being in any way limited to the presented examples. The scope of the present invention is to be interpreted in the light of the accompanying claim set. In the context of the claims, the terms “including” or “includes” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A computer implemented method for test of a control system for a logistics system, the method comprising
emulating a high level response of an overall layout of the logistics system for testing a high level control software for overall control of the logistics system,
emulating a low level response of physical elements of the logistics system for testing one or more low level control software parts for control of physical elements of the logistics system,
interfacing the high level emulation and the low level emulation, by two-way exchanging a plurality of parameters indicative of items to be handled in the logistics system between the high level emulation and the low level emulation, and
testing one or more low level control software parts by simultaneously emulating said high level response, emulating said low level emulating response, and interfacing said high level emulation and low level emulation.

2. The method according to claim 1, wherein the plurality of parameters indicative of items to be handled comprises as least one parameter indicative of one of: a unique identity for each item, and a time stamp associated with location of each item in the overall layout.

3. The method according to claim 1, wherein the plurality of parameters indicative of items to be handled comprises at least one parameter indicative of one of: destination of the item, content of the item, and status information.

4. The method according to claim 1, wherein the interface is configured to allow real-time two-way exchange of at least three parameters unique for each items to be handled.

5. The method according to claim 1, wherein the low level emulation program code is configured to emulate electric inputs and outputs of the physical elements of the logistics system.

6. The method according to claim 1, wherein the low level emulation program code is configured to emulate response of a plurality of physical elements associated with a plurality of low level control software parts.

7. The method according to claim 6, wherein the interfacing further comprises emulating response of an interconnection between at least two low level control software parts.

8-9. (canceled)

10. The method according to claim 1, comprising simultaneously testing a plurality of low level control software parts.

11. The method according to claim 1, wherein the high level emulation and the low level emulation are executed on separate processors.

12-14. (canceled)

15. The method according to claim 1, comprising receiving a set of input data for a plurality of items originating from a real-life logistics system, and applying said set of input data to the high level control software.

16. (canceled)

17. The method according to claim 1, comprising visualizing to a user at least a part of the logistics system and at least one item being transported therein to a user along with said step of testing.

18. The method according to claim 1, wherein the one or more low level control software parts are Programmable Logic Control software parts or software parts for Field Programmable Gate Arrays.

19. The method according to claim 1, wherein the testing is performed in real-time or faster than real-time.

20. A computer system comprising at least one processor and a memory and being programmed for carrying out the method according to claim 1.

21. A computer program product having instructions which when executed cause a computing system to perform the emulating of a high level response, the emulating of a low level response, and the interfacing according to the method of claim 1.

22. The computer program product according to claim 21, being one of: a software product for a general computer, a server software product, and a plurality of separate software products configured for execution on separate processors.

23. A computer readable medium having stored thereon a computer program product according to claim 21.

24. Use of the method according to claim 1 for test of a control system for a logistics system being one of: an airport baggage handling system, a mail or parcel sorting system, an item or material storage facility, and a material conveying system.

25. A logistics system for handling items, the system comprising
a plurality of physical elements comprising
at least one conveyor section arranged to transport a stream of items,
at least one induction arranged for transporting items to the at least one conveyor,
at least a discharge arranged for discharging items from the at least one conveyor, and
a control system for controlling the physical elements, wherein the control system comprises a computer system programmed to control the physical elements according to a high level control software and one or more low level control software parts, wherein said high level control software and one or more low level control software parts have been tested according to the method according to claim 1.

26. The logistics system according to claim 25 being one of: an airport baggage handling system, a mail or parcel sorting system, an item or material storage facility, and a material conveying system.

27. (canceled)
